(19) United States
(12) Patent Application Publication
(10) Pub. No.: US 2023/0321631 A1
(43) Pub. Date: Oct. 12, 2023

(54) Cerium-zirconium-based composite oxide with core-shell structure and preparation method thereof

(71) Applicants: Rare Earth Functional Materials (Xiong 'an) Innovation Center Co., Ltd., Baoding, Hebei (CN); GRIREM ADVANCED MATERIALS CO., LTD, Beijing (CN); GRIREM HI-TECH CO., LTD., Langfang, Hebei (CN)

(72) Inventors: Yongqi ZHANG, Beijing (CN); Zheng ZHAO, Beijing (CN); Xiaowei HUANG, Beijing (CN); Yongke HOU, Beijing (CN); Meisheng CUI, Beijing (CN); Zhizhe ZHAI, Beijing (CN); Zongyu FENG, Beijing (CN); Juanyu YANG, Beijing (CN); Yang XU, Beijing (CN)

(21) Appl. No.: 18/027,041

(22) PCT Filed: Aug. 27, 2021
(86) PCT No.: PCT/CN2021/114928

§ 371 Date: Mar. 17, 2023

(30) Foreign Application Priority Data
Sep. 17, 2020 (CN) 202010982980.5

(51) Int. Cl. B01J 21/06; B01J 23/10; B01J 37/03; B01J 37/00; B01J 37/08

(52) U.S. Cl. CPC B01J 21/066; B01J 23/10; B01J 37/038; B01J 37/009; B01J 37/08

(57) ABSTRACT

The present disclosure provides a cerium-zirconium-based composite oxide with a core-shell structure and a preparation method thereof, a catalyst system using the cerium-zirconium-based composite oxide, a catalytic converter for purifying tail gas by using the catalyst system, and application of the catalyst system or the catalytic converter in motor vehicle exhaust purification, industrial waste gas treatment or catalytic combustion. In the present invention, the cerium-zirconium-based composite oxide with a core-shell structure oxygen storage material is prepared by a step-by-step precipitation method. On the one hand, yttrium and a part of zirconium and cerium are precipitated on a cerium-zirconium surface, where the post-precipitation of yttrium is to segregate yttrium ions (Y³⁺) on a grain boundary surface, thus reducing lattice surface energy, pinning the grain boundary surface, making the migration of the grain boundary surface difficult, controlling the growth of grains.

### CROSS-REFERENCE TO RELATED APPLICATIONS

This Application is a national stage application of PCT/CN2021/114928. This application claims priorities from PCT Application No. PCT/CN2021/114928, filed Aug. 27, 2022, and from the Chinese patent application 202010982980.5 filed Sep. 17, 2020, the content of which are incorporated herein in the entirety by reference.

### TECHNICAL FIELD

The present disclosure relates to related fields of catalysts and preparation thereof, in particular to a cerium-zirconium-based composite oxide with a core-shell structure that can be used in the fields of motor vehicle exhaust purification, industrial waste gas treatment, catalytic combustion, etc., and a preparation method thereof.

### BACKGROUND

In recent years, air pollution has attracted much attention. As the number of vehicles in China and even in the world increases year by year, vehicle exhaust pollution has become the primary source of urban air pollution, and the environmental problems are increasingly severe. Cerium-zirconium oxygen storage materials are indispensable key cocatalyst materials in vehicle exhaust purification. Especially in China VI vehicle emission stage, cerium-zirconium oxygen storage materials are required to have a large enough specific surface area and high enough oxygen storage and release capabilities in high temperature environments.

In order to solve these problems, patent document CN 103191711 A provides a method of coprecipitation of a zirconium salt, a cerium salt and other rare earth metal salts to obtain a cerium-zirconium composite oxide with good heat resistance, which has a specific surface area of more than 20 m²/g after calcination at 1100° C. for 3 hours. However, the improvement of heat resistance of cerium-zirconium oxides by this method is still limited.

It is further found that step-by-step precipitation is beneficial to improving sintering resistance. For example, patent document CN 101091914 B provides a method of first precipitating a zirconium salt and other rare earth metal salts except cerium, and then precipitating a cerium salt, which improves the specific surface heat resistance of a cerium-zirconium composite oxide at a high temperature (1000/3 h). However, due to the easy sintering of cerium on the outer layer, the specific surface heat resistance at a high temperature is still not ideal (20-22 m²/g) after heat treatment at 1100° C. for 3 h. Patent document CN 103962120 A provides that a part of yttrium salt, other rare earth metal salts except yttrium, and a zirconium salt are first in contact with an alkaline matter, and then the remaining part of yttrium salt or the remaining part of at least one compound of yttrium and rare earth metal is in contact with the alkaline matter, which improves the specific surface heat resistance of a cerium-zirconium composite oxide at a high temperature (1000/4 h). However, because any stable core-shell structure is not formed and the sintering resistance of the outer layer is weak in the presence of only rare earth metal salts on the surface, the specific surface heat resistance at a high temperature is still not ideal (15-30 m²/g) after heat treatment at 1100° C. for 4 h.

### SUMMARY

Based on the above situation of the prior art, it is urgent to develop a cerium-zirconium-based composite oxide which can maintain sufficient thermal stability in a high temperature environment of 1100° C. to improve the durability of a catalyst. The objective of the present disclosure is to provide a cerium-zirconium-based composite oxide with a core-shell structure and a preparation method thereof by which an yttrium oxide-enriched shell can be constructed on the outer layer, where the cerium-zirconium-based composite oxide exhibits high heat resistance and is capable of maintaining a large specific surface area even when used in a high temperature environment.

To achieve the above objective, according to an aspect of the present disclosure, a cerium-zirconium-based composite oxide with a core-shell structure is provided, the composite oxide including an yttrium oxide, a cerium oxide and a zirconium oxide, where the content of yttrium oxide in a shell layer of the composite oxide is higher than that in the overall composite oxide, and a core layer of the composite oxide is a cerium-zirconium-based composite oxide.

Further, percentage by mole (%), the content of yttrium oxide in the shell layer of the composite oxide is 1.1-5.0 times of that in the overall composite oxide, let the yttrium ions converge on the grain surface, inhibit the high temperature sintering of cerium zirconium compound oxide, and improve the thermal stability of cerium zirconium compound oxide. The content of yttrium oxide in the core layer is lower than that in the overall composite oxide; the content of zirconium oxide in the shell layer of the composite oxide is 5%-40% of that in the overall composite oxide, enhancing the thermal stability of cerium-zirconium composite oxides and the content of zirconium oxide in the core layer is higher than that in the overall composite oxide.

Further, the composite oxide includes the following terms represented as oxides:
10%-60% by mole of cerium oxide;
20%-70% by mole of zirconium oxide;
1%-20% by mole of yttrium oxide;
and 0%-20% by mole of other oxides.

Further, the other oxides are one or a combination of more than one of oxides of rare earth elements except cerium and yttrium, and oxides of non-rare earth elements except zirconium, the content of the other oxides in the composite oxide is 0%-18% by mole, and the content of the oxides of rare earth elements except cerium and yttrium in the other oxides is 0%-100% by mole.

Further, the content of the other oxides in the composite oxide is 2%-15% by mole, and the content of the oxides of rare earth elements except cerium and yttrium in the other oxides is 50%-100% by mole.

Further, in the other oxides, the rare earth elements except cerium and yttrium and the non-rare earth elements except zirconium are one or a combination of more than one of lanthanum, praseodymium, neodymium, samarium, europium, gadolinium, terbium, dysprosium, holmium, erbium, thulium, ytterbium, lutetium, scandium, hafnium, aluminum, barium, manganese, and copper.

Further, in the other oxides, the rare earth elements except cerium and yttrium and the non-rare earth elements except zirconium are one or a combination of more than one of lanthanum, praseodymium, neodymium, europium, aluminum, and manganese.

Further, the content of yttrium oxide in the shell layer is 1.5%-65% by mole of the total element content of the shell layer, and is at least higher than the content of yttrium oxide in the overall composite oxide.

Further, the oxides of rare earth elements except cerium and yttrium and the oxides of non-rare earth elements except zirconium in the shell layer are 0%45% by mole of the total element content of the shell layer.

Further, the composite oxide has:
a specific surface area of more than 60 m²/g after heat treatment at 1000° C. in air for 4 hours; and
a specific surface area of more than 50 m²/g after heat treatment at 1100° C. in air for 4 hours.

Further, after the composite oxide is calcined at 1000° C. in air for 4 hours, its static oxygen storage capacity is more than or equal to 600 μmol O₂/g.

Further, after the composite oxide is calcined at 1100° C. in air for 4 hours, its static oxygen storage capacity is more than or equal to 500 μmol O₂/g.

According to a second aspect of the present disclosure, a preparation method of the cerium-zirconium-based composite oxide with a core-shell structure is provided, the preparation method being a step-by-step precipitation method, including the following steps:

(a) First precipitation step: mixing an alkaline matter with an aqueous solution containing 80-100% by mole of cerium salt, 60-99% by mole of zirconium salt, and optionally at least one rare earth salt except the cerium salt and a yttrium salt or non-rare earth salt except the zirconium salt for precipitation to obtain a precipitate slurry A containing at least cerium and zirconium;

(b) Second precipitation step: adding the yttrium salt, a solution of the remaining part of zirconium salt or cerium salt, and the alkaline matter to the slurry A for precipitation to obtain a precipitate slurry B containing at least zirconium, cerium and yttrium; and

(c) Adding a modifier to the slurry B for surface modification treatment, filtering to obtain a cerium-zirconium-based composite precipitate C, and calcining at 600° C.-950° C. to obtain the cerium-zirconium-based composite oxide.

Further, the precipitate slurry A or B is aged.

Further, the aqueous solution of the rare earth salt is one or a combination of more than one of a rare earth nitrate solution, a chloride solution, a sulfate solution, and an acetate solution. The aqueous solution of the zirconium salt is one or a combination of more than one of a zirconium oxynitrate solution, a zirconium oxysulfate solution, a zirconium oxychloride solution, and a zirconium acetate salt.

Further, the alkaline matter is one or a combination of more than one of sodium hydroxide, ammonium hydroxide, potassium hydroxide, urea, ammonium bicarbonate, sodium carbonate, and sodium bicarbonate.

Further, the molar ratio of coordination agent ions to zirconium ions in the aqueous solution of the rare earth salt is 0.2-3.0, and the coordination agent ions are sulfate anions.

Further, the molar ratio of the coordination agent ions to the zirconium ions is 0.5-2.5.

Further, the modifier includes one or more of an anionic surfactant, a nonionic surfactant, polyethylene glycol, carboxylic acid and salts thereof, and a carboxymethylated fatty alcohol ethoxylate type surfactant.

According to a third aspect of the present disclosure, a catalyst system is provided, the catalyst system including the cerium-zirconium-based composite oxide provided in the first aspect of the present disclosure, or a cerium-zirconium-based composite oxide prepared by the preparation method provided in the second aspect of the present disclosure, and one or more of alumina, transition metals, precious metals, and carriers.

According to a fourth aspect of the present disclosure, a catalytic converter is provided for purifying tail gas by using the catalyst system as provided in the third aspect of the present disclosure.

According to a fifth aspect of the present disclosure, application of the cerium-zirconium-based composite oxide as provided in the first aspect of the present disclosure, the catalyst system as provided in the third aspect of the present disclosure, or the catalytic converter as provided in the fourth aspect of the present disclosure in motor vehicle exhaust purification, industrial waste gas treatment or catalytic combustion is provided.

To sum up, the present disclosure provides a cerium-zirconium-based composite oxide with a core-shell structure and a preparation method thereof, a catalyst system using the cerium-zirconium-based composite oxide, a catalytic converter for purifying tail gas by using the catalyst system, and application of the catalyst system or the catalytic converter in motor vehicle exhaust purification, industrial waste gas treatment or catalytic combustion. In the present disclosure, the cerium-zirconium-based composite oxide with a core-shell structure oxygen storage material is prepared by a step-by-step precipitation method. On the one hand, yttrium and a part of zirconium are precipitated on a cerium-zirconium surface, where the post-precipitation of yttrium is to segregate yttrium ions (Y³⁺) on a grain boundary surface, thus reducing lattice surface energy, pinning the grain boundary surface, making the migration of the grain boundary surface difficult, controlling the growth of grains, inhibiting the high-temperature sintering phenomenon of a solid solution, and then improving the thermal stability of the solid solution; and the post-precipitation of a part of zirconium is to enhance the thermal stability. On the other hand, are yttrium ions and other rare earth or non-rare earth ions have a smaller ion radius and charge amount, which is more conducive to reducing the formation of oxygen vacancies and improving the oxygen storage and release performance, so as to meet the use requirements of three-way catalysts (TWC) for different gasoline vehicles for oxygen storage materials.

### BRIEF DESCRIPTION OF THE DRAWINGS

FIG. 1 is a schematic flowchart of a preparation method of a core-shell cerium-zirconium-based composite oxide of the present disclosure; and

FIG. 2 is an XRD diffraction diagram of the cerium-zirconium-based composite oxide with a core-shell structure in the present disclosure.

### DETAILED DESCRIPTION OF THE DISCLOSURE

In order to make the objectives, technical solutions and advantages of the present disclosure clearer, the present disclosure is further described in detail below in combination with specific embodiments and the accompanying drawings. It should be understood that these descriptions are exemplary only and are not intended to limit the scope of the present disclosure. In addition, descriptions on well-known structures and technologies are omitted below in order to avoid unnecessarily obscuring the concept of the present disclosure.

The present disclosure measures various physical properties using the following methods:

### (1) Specific Surface Area

According to the BET method, the specific surface area was measured using a specific surface and pore size analyzer (Quadrasorb Evo). First, a sample was continuously pretreated by vacuum degassing at 280° C. for 1 hour, the sample tube was soaked in high-purity liquid nitrogen (−196° C.) for adsorption test, and the desorption test was carried out at room temperature (25° C.). A static BET method was used for measurement, and the specific surface area was calculated by BET theory based on points within a P/PO range of 0.05-0.3.

### (2) Static Oxygen Storage Capacity (OSC)

According to an oxygen pulse method, the oxygen storage capacity was measured using a chemical adsorption instrument (ChemBET Pulsar TPR/TPD). More specifically, the sample was purged with HE, heated to 150° C., continuously heated to 800° C. and then reduced with 10% H₂/Ar for 1 hour, the temperature of the reactor was reduced to 500° C. in HE gas flow, the residual H₂ was purged thoroughly, high-purity O₂ was introduced by pulse at 500° C., and the total oxygen storage capacity was calculated by counting the peak area of O₂ consumption.

### (3) Test of Total Component Content

The total component content was tested using an ICP (Inductively Coupled Plasma Emission Spectrometer) at the wavelengths corresponding to various elements according to the characteristic radiation energy emitted by radiation transition when electrons on the outer layer returned from an excited state to a ground state after sample atoms (or ions) were excited.

### (4) Test of Surface Element Content

The surface element content was tested by XPS, and the excitation source was X-ray, which acted on the surface of the sample to produce photoelectrons. Photoelectron spectra were obtained by analyzing the energy distribution of photoelectrons. Further, the content of elements on the surface of the material was analyzed through the shape, position and intensity of photoelectron peaks.

A first aspect of the present disclosure provides a cerium-zirconium-based composite oxide with a core-shell structure. The composite oxide includes an yttrium oxide, a cerium oxide and a zirconium oxide, where the content of yttrium oxide in a shell layer of the composite oxide is higher than that in the overall composite oxide, and a core layer is a cerium-zirconium-based composite oxide. In percentage by mole (%), the content of yttrium oxide in the shell layer of the composite oxide is 1.1-5.0 times that in the overall composite oxide, and the content of yttrium oxide in the core layer is lower than that in the overall composite oxide; the content of zirconium oxide in the shell layer of the composite oxide is 5%-40% of that in the overall composite oxide, and the content of zirconium oxide in the core layer is higher than that in the overall composite oxide. Typically, oxide grains have a radius of 3-20 nm, and according to some embodiments, the shell layer of the oxide may have a thickness of 1-3 nm. By constructing the cerium-zirconium-based composite oxide with the above structure, the oxide exhibits high heat resistance and is capable of maintaining a large specific surface area even when used in a high temperature environment.

According to some embodiments, the composite oxide includes the following items represented as oxides: 10%-60% by mole of cerium oxide; 20%-70% by mole of zirconium oxide; 1%-20% by mole of yttrium oxide; and 0%-20% by mole of other oxides. Further, the composite oxide may be represented by the following general formula of oxides: (CeO₂)ₓ(ZrO₂)_{y}(Y₂O₃)_{z}(MOₘ)ₙ, where 0.1≤x≤0.6, 0.2≤y≤0.7, 0.01≤z≤0.2, M is one or a combination of more than one of the rare earth elements except cerium and yttrium and non-rare earth metal elements except zirconium, 0≤n≤0.2, and m may be determined according to the selection of the M element.

The other oxides are one or a combination of more than one of oxides of rare earth elements except cerium and yttrium and non-rare earth metal element oxides except zirconium, the content of the other oxides in the composite oxide is 0%-18% by mole, and the content of the oxides of rare earth elements except cerium and yttrium in the other oxides is 0%-100% by mole. According to some embodiments, the content of the other oxides in the composite oxide is 2%-15% by mole, and the content of the oxides of rare earth elements except cerium and yttrium in the other oxides is 50%-100% by mole.

In the other oxides, the rare earth elements except cerium and yttrium and non-rare earth metal elements except zirconium are one or a combination of more than one of lanthanum, praseodymium, neodymium, samarium, europium, gadolinium, terbium, dysprosium, holmium, erbium, thulium, ytterbium, lutetium, scandium, hafnium, aluminum, barium, manganese, and copper. According to some embodiments, in the other oxides, the rare earth elements except cerium and yttrium and the non-rare earth elements except zirconium may be one or a combination of more than one of lanthanum, praseodymium, neodymium, europium, aluminum, and manganese.

The content of yttrium oxide in the shell layer is 1.5%-65% by mole of the overall shell layer and is at least higher than the content of yttrium oxide in the overall composite oxide, and the content of oxides of rare earth elements except cerium and yttrium and oxides of non-rare earth elements except zirconium in the shell layer is 0%-15% by mole of the overall shell layer.

The composite oxide has a specific surface area of more than 60 m²/g after heat treatment at 1000° C. in air for 4 hours; and a specific surface area of more than 50 m²/g after heat treatment at 1100° C. in air for 4 hours. After the composite oxide is calcined at 1000° C. in air for 4 hours, its oxygen storage capacity is more than or equal to 600 μmol O₂/g. After the composite oxide is calcined at 1100° C. in air for 4 hours, its oxygen storage capacity is more than or equal to 500 μmol O₂/g. Therefore, it can be seen that the composite oxide provided by the embodiment of the present disclosure has higher specific surface area and static oxygen storage capacity.

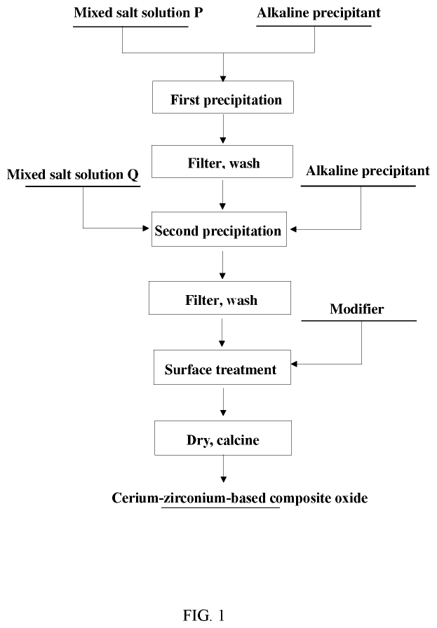

A second aspect of the present disclosure provides a preparation method of the cerium-zirconium-based composite oxide with a core-shell structure. The preparation method is a step-by-step precipitation method. The schematic flowchart of the method is shown in FIG. 1. In FIG. 1, the mixed salt solution P represents an aqueous solution of 80-100% of cerium salt, 60-99% of zirconium salt and optionally at least one rare earth salt except the cerium salt and a yttrium salt or non-rare earth metal salt except the zirconium salt, and the mixed salt solution Q represents an aqueous solution of the yttrium salt and the remaining proportion of zirconium salt and cerium salt, which are required in a stoichiometric amount to prepare a final product. The preparation method includes the following steps:

An aqueous solution of 80-100% of cerium salt, 60-99% of zirconium salt and optionally at least one rare earth salt except the cerium salt and a yttrium salt or non-rare earth metal salt except the zirconium salt, which are required in a stoichiometric amount for a final product, is prepared, where the aqueous solution has a concentration of 0.1-5 mol/L, preferably 0.2-2.0 mol/L.

A mixed aqueous solution of the prepared aqueous solution of the zirconium salt, the cerium salt and the optionally at least one rare earth salt except the cerium salt and the yttrium salt or non-rare earth metal salt except the zirconium salt is in contact with an alkaline matter, followed by precipitation, filtration, washing, dispersion, and post-treatment including one or two of aging or crystallization to obtain a precipitate slurry A containing at least cerium and zirconium, where the slurry A has a concentration of 40-60%, preferably 45-55%.

The yttrium salt, the remaining proportion of zirconium salt and cerium salt, and ammonium hydroxide are added to the slurry A for second precipitation, followed by filtration, washing, dispersion, and post-treatment including one or two of aging or crystallization to obtain a precipitate slurry B containing at least zirconium, cerium and yttrium, where the slurry B has a concentration of 40-70%, preferably 45-60%.

The slurry B is heated and added with a modifier, a cerium-zirconium-based composite precipitate C is obtained after filtration, and the cerium-zirconium-based composite oxide is obtained after optional drying, calcination and crushing.

In this embodiment of the present disclosure, the composite oxide is prepared by a step-by-step precipitation method, which can construct a shell layer structure with a yttrium oxide and a zirconium oxide on the outer layer, such that yttrium ions (Y³⁺) are segregated on a grain boundary surface to reduce lattice surface energy, pin the grain boundary surface, make the migration of the grain boundary surface difficult, control the growth of grains, inhibit the high-temperature sintering phenomenon of a solid solution, and thereby improve the thermal stability of the solid solution. the post-precipitation of a part of zirconium is to promote the thermal stability. On the other hand, yttrium ions (Y³⁺, 0.90 Å) have a smaller ion radius and quantity of charges, which is more conducive to lattice oxygen diffusion and improvement of oxygen storage and release performance.

Further, the aqueous solution of the rare earth salt is one or a combination of more than one of rare earth nitrate, chloride, sulfate, and acetate. The aqueous solution of the zirconium salt is one or a combination of more than one of a zirconium oxynitrate solution, a zirconium oxychloride solution, and a zirconium acetate salt. The aqueous solution of the rare earth salt may contain 0.2 mole to 3 moles of coordination agent ions, preferably sulfate anions (SO₄²⁻), per mole of zirconium. The molar ratio of the coordination agent ions to zirconium ions ranges from 0.5 to 2.5, and the sulfate anions (SO₄²⁻) may be provided by adding sulfuric acid or sulfate to the aqueous solution of the rare earth salt.

According to some embodiments, the alkaline matter may be one or a combination of more than one of sodium hydroxide, ammonium hydroxide, potassium hydroxide, urea, ammonium bicarbonate, sodium carbonate, and sodium bicarbonate. The amount of the alkaline matter may be stoichiometrically overused in the precipitation reaction to provide optimal precipitation of all cations. Generally, a sufficient amount is such that the pH value of the solution is not less than 8, and a preferred amount is such that the pH value is between 8 and 12. The precipitation reaction is usually carried out at a temperature between 5° C. and 50° C., preferably in a range of 15° C. to 30° C. The stirring rate used is between 50 and 500 rpm, and the time is usually between 1 hour and 3 hours. The modifier includes one or more of an anionic surfactant, a nonionic surfactant, polyethylene glycol, carboxylic acid and salts thereof, and a carboxymethylated fatty alcohol ethoxylate type surfactant.

Further, the calcination condition is that the obtained cerium-zirconium-based composite precipitate C is calcined at 600° C.-950° C. in air for more than 1 hour, preferably at 650° C.-900° C. in air for more than 3 hours. The heating and aging treatment is usually carried out at a temperature between 25° C. and 90° C., preferably in a range of 30° C. to 80° C. The heating and crystallization treatment is usually carried out at a temperature between 40° C. and 200° C., preferably in a range of 60° C. to 180° C. The stirring rate used is between 50 and 500 rpm, and the time is usually between 1 hour and 5 hours. It should be noted that when the cerium salt contains Ce III, an oxidant, such as an aqueous solution of hydrogen peroxide, may also be added in the aging step.

A third aspect of the present disclosure provides a catalyst system. The catalyst system includes the cerium-zirconium-based composite oxide provided in the first embodiment of the present disclosure, or a cerium-zirconium-based composite oxide prepared by the preparation method provided in the second embodiment of the present disclosure, and one or more of alumina, transition metals, precious metals, and carriers.

A fourth aspect of the present disclosure provides a catalytic converter for purifying tail gas by using the catalyst system as provided in the third aspect.

A fifth aspect of the present disclosure provides application of the cerium-zirconium-based composite oxide as provided in the first aspect, the catalyst system as provided in the third aspect, or the catalytic converter as provided in the fourth aspect in motor vehicle exhaust purification, industrial waste gas treatment or catalytic combustion.

The present disclosure is further explained below by specific examples.

### Comparative Example 1

This comparative example relates to the preparation of composite oxides based on cerium, zirconium, yttrium and lanthanum in corresponding proportions of 40%, 50%, 5%, 5% by mole fraction of oxides.

The brief preparation process is as follows: pre-configuring a mixed feed solution containing cerium chloride, zirconium oxychloride, yttrium chloride and lanthanum chloride. The mixed liquid is added to the stoichiometric ratio of sodium hydroxide for precipitation, and the precipitate is filtered and washed. The obtained filter cake is slurried and then added with polyethylene glycol and heated, and filtered after stirring.

The specific preparation process is as follows: pre-configured containing 101.24 mL of CeCl₃ solution with a concentration of 1.5 mol/L, 126.55 mL of ZrOCl₂ with a concentration of 1.5 mol/L, 25.31 mL of YCl₃ with a concentration of 1.5 mol/L, and 25.31 mL of a concentration of 1.5 mol/L LaCl₃ and 83.39 mL of a mixed feed solution with a concentration of 2.1 mol/L H₂SO₄, the mixed feed solution was added to 536.31 mL of a 2.69 mol/L NaOH solution for precipitation, and the precipitate was filtered and washed. The washed precipitate was slurried and heated to 55° C. for 2 hours. After filtering and washing, polyethylene glycol was added, and the mixture was placed in an autoclave and treated at 120° C. for 6 hours. The suspension was filtered and dried, then calcined in a muffle furnace at 850° C. for 4 hours, taken out, ground, and the composite oxide was calcined at 1000° C. and 1100° C. for 4 hours to obtain the product.

### Comparative Example 2

This comparative example relates to the preparation of composite oxides based on cerium, zirconium, yttrium, lanthanum and aluminium in corresponding proportions of 40%, 40%, 5%, 7.5% and 7.5% in terms of oxide mole fraction.

A brief preparation process is as follows: pre-configuring a mixed feed solution containing cerium chloride, zirconium oxychloride, yttrium chloride, lanthanum chloride and aluminum chloride. The mixed liquid is added to the stoichiometric ratio of sodium hydroxide for precipitation, and the precipitate is filtered and washed. After beating the obtained filter cake, cetyltrimethylammonium bromide (CTAB) was added thereto, heated, and filtered after stirring.

The specific preparation process is as follows: pre-configured containing 99.05 mL of CeCl₃ solution with a concentration of 1.5 mol/L, 99.06 mL of ZrOCl₂ with a concentration of 1.5 mol/L, 24.76 mL of YCl₃ with a concentration of 1.5 mol/L, and 37.15 mL of a concentration of 1.5 mol/L LaCl₃, 37.15 concentration of 1.5 mol/L AlCl₃ and 211.50 mL concentration of 2.1 mol/L H₂SO₄ mixed feed solution, the mixed feed solution was added to 550.38 mL concentration of 2.69 mol/L NaOH solution for precipitation. After filtering and washing, CTAB was added and placed in an autoclave, and treated at 150° C. for 2 hours. The suspension was filtered and dried, then calcined in a muffle furnace at 950° C. for 3 hours, taken out, ground, and the composite oxide was calcined at 1000° C. and 1100° C. for 4 hours to obtain the product.

### Example 1

This example relates to the preparation of a composite oxide of 10% of cerium, 70% of zirconium, and 20% of yttrium based on mole fractions of oxides.

The brief preparation process was as follows: two salt solutions were prepared in advance, the first one was a mixed solution Si containing 90% of zirconium oxychloride and 90% of cerium chloride, and the second one was a solution S2 of yttrium chloride and the remaining proportion of zirconium oxychloride and cerium chloride. The first mixed solution was added to stoichiometric sodium hydroxide for first precipitation. Then, the second solution of yttrium chloride, zirconium oxychloride and cerium chloride, and sodium hydroxide were added thereto for second precipitation, the precipitate was filtered and washed, the obtained filter cake was slurried and heated, and then lauric acid was added, followed by stirring and filtration.

The specific preparation process was as follows: two salt solutions were prepared in advance, where the first salt solution was composed of 24.22 mL of 1.5 mol/L CeCl₃ solution, 169.55 mL of 1.5 mol/L ZrOCl₂ and 104.56 mL of 2.1 mol/L H₂SO₄ solution, and the second salt solution was composed of 107.64 mL of 1.5 mol/L YCl₃, 2.69 mL of 1.5 mol/L CeCl₃ solution and 18.83 mL of 1.5 mol/L ZrOCl₂ solution. The first salt solution was first added to 640.79 mL of 2.69 mol/L NaOH solution for precipitation, and the precipitate was filtered and washed. The second mixed salt solution was then introduced into the washed precipitate slurry and stoichiometric NaOH was added, such that yttrium ions, cerium ions and zirconium ions were precipitated on the surface. After precipitation, the precipitate was heated to 55° C. and maintained for 2 hours. 120° C. for 2 hours. Filtered the suspension and dried, then calcined in a muffle furnace at 850° C. for 4 hours, taken out, ground, and calcined at 1000° C. and 1100° C. for 4 hours to obtain a product.

### Example 2

This example relates to the preparation of a composite oxide of 20% of cerium, 59% of zirconium,3% of yttrium and 18% of lanthanum based on mole fractions of oxides.

The specific preparation process was as follows: two salt solutions were prepared in advance, where the first salt solution was composed of 37.09 mL of 1.5 mol/L CeCl₃ solution, 129.93 mL of 1.5 mol/L ZrOCl₂, 83.45 mL of 1.5 mol/L LaCl₃ and 197.13 mL of 2.1 mol/L H₂SO₄ solution, and the second salt solution was composed of 13.90 mL of 1.5 mol/L YCl₃, 9.27 mL of 1.5 mol/L CeCl₃ solution and 6.83 mL of 1.5 mol/L ZrOCl₂ solution. The first salt solution was first added to 526.95 mL of 2.69 mol/L NaOH solution for precipitation, and the precipitate was filtered and washed. The second mixed salt solution was then introduced into the washed precipitate slurry within 15 minutes and stoichiometric NaOH was added, such that yttrium ions, cerium ions and zirconium ions were precipitated on the surface. After filtering and washing, After filtration washing, capic acid was added and placed in an autoclave and treated at 150° C. for 2 hours. The suspension was filtered and dried, then calcined in a muffle furnace at 800° C. for 3 hours, taken out, ground, and calcined at 1000° C. and 1100° C. for 4 hours to obtain a product.

### Example 3

This example relates to the preparation of a composite oxide of 40% of cerium, 50% of zirconium, 5% of yttrium and 5% of lanthanum based on mole fractions of oxides.

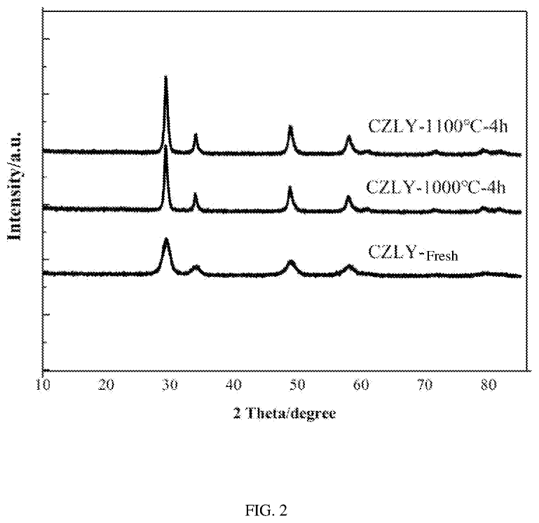

The specific preparation process was as follows: two salt solutions were prepared in advance, where the first salt solution was composed of 91.11 mL of 1.5 mol/L CeCl₃ solution, 120.22 mL of 1.5 mol/L ZrOCl₂, 25.31 mL of 1.5 mol/L LaCl₃ and 90.39 mL of 2.1 mol/L H₂SO₄ solution, and the second salt solution was composed of 25.31 mL of 1.5 mol/L YCl₃, 10.12 mL of 1.5 mol/L CeCl₃ solution and 6.32 mL of 1.5 mol/L ZrOCl₂ solution. The first salt solution was first added to 536.31 mL of 2.69 mol/L NaOH solution for precipitation, and the precipitate was filtered and washed. The second mixed salt solution was then introduced into the washed precipitate slurry and stoichiometric NaOH was added, such that yttrium ions, cerium ions and zirconium ions were precipitated on the surface. After precipitation, the slurry was heated to 55° C. and maintained for 2 hours, After filtration and washing, PEG was added and placed in an autoclave and treated at 120° C. for 6 hours. The suspension was filtered and dried, then calcined in a muffle furnace at 850° C. for 4 hours, taken out, ground, and calcined at 1000° C. and 1100° C. for 4 hours to obtain a product. The XRD patterns of C_{0.40}Z_{0.50}L_{0.5}Y_{0.5} fresh and aged (1000° C.×4 h and 1100° C.×4 h) samples prepared by step-by-step precipitation in Example 3 were shown in FIG. 2. From the figure, it can be found that the fresh and aged composite oxides had tetragonal stable crystal structures, phase separation did not occur at high temperature, and the phase structure remained uniform.

### Example 4

This example relates to the preparation of a composite oxide of 50% of cerium, 30% of zirconium, 10% of yttrium and 10% of lanthanum based on mole fractions of oxides.

The specific preparation process was as follows: two salt solutions were prepared in advance, where the first salt solution was composed of 101.01 mL of 1.5 mol/L CeCl₃ solution, 63.97 mL of 1.5 mol/L ZrOCl₂, 44.89 mL of 1.5 mol/L LaCl₃ and 120.25 mL of 2.1 mol/L H₂SO₄ solution, and the second salt solution was composed of 44.89 mL of 1.5 mol/L Y(NO₃)₃, 11.22 mL of 1.5 mol/L Ce (NO₃)₄ solution and 3.36 mL of 1.5 mol/L ZrO(NO₃)₂ solution. The first salt solution was first added to 488.18 mL of 2.69 mol/L NaOH solution for precipitation, and the precipitate was filtered and washed. After dispersion, the slurry was heated to 60° C. and maintained for 3 hours, After filtration and washing, PEG was added After re-dispersion, the obtained slurry was placed in an autoclave, 98° C. for 1.5 hours. the second mixed salt solution was introduced into the washed precipitate slurry and stoichiometric NH₄OH was added, such that yttrium ions, cerium ions and zirconium ions were precipitated on the surface. The suspension was filtered and dried, then calcined in a muffle furnace at 800° C. for 6 hours, taken out, ground, and calcined at 1000° C. and 1100° C. for 4 hours to obtain a product.

### Example 5

This example relates to the preparation of a composite oxide of 60% of cerium, 20% of zirconium, 18% of yttrium and 2% of lanthanum based on mole fractions of oxides.

The specific preparation process was as follows: two salt solutions were prepared in advance, where the first salt solution was composed of 137.08 mL of 1.5 mol/L CeCl₃ solution, 45.94 mL of 1.5 mol/L ZrOCl₂, 9.28 mL of 1.5 mol/L LaCl₃ and 83.14 mL of 2.1 mol/L H₂SO₄ solution, and the second salt solution was composed of 82.24 mL of 1.5 mol/L Y(NO₃)₃ solution and 0.46 mL of 1.5 mol/L ZrO(NO₃)₂ solution. The first salt solution was first added to 484.12 mL of 2.69 mol/L NaOH solution for precipitation, and the precipitate was filtered and washed. Then, the slurry was heated to 70° C. and maintained for 3 hours After filtration and washing, oleic acid was placed in an autoclave, 150° C. for 6 hours. the second mixed salt solution was introduced into the washed precipitate slurry and stoichiometric NH₄OH was added, such that yttrium ions and zirconium ions were precipitated on the surface. The suspension was filtered and dried, then calcined in a muffle furnace at 900° C. for 3 hours, taken out, ground, and calcined at 1000° C. and 1100° C. for 4 hours to obtain a product.

### Example 6

This example relates to the preparation of a composite oxide of 40% of cerium, 40% of zirconium, 1% of yttrium and 19% of praseodymium based on mole fractions of oxides.

The specific preparation process was as follows: two salt solutions were prepared in advance, where the first salt solution was composed of 40.70 mL of 1.5 mol/L CeCl₃ solution, 48.33 mL of 1.5 mol/L ZrOCl₂, 145.00 mL of 1.5 mol/L PrCl₃ and 16.34 mL of 2.1 mol/L H₂SO₄ solution, and the second salt solution was composed of 2.54 mL of 1.5 mol/L Y(NO₃)₃, 10.17 mL of 1.5 mol/L Ce(NH₄)₂(NO₃)₆ solution and 2.54 mL of 1.5 mol/L ZrO(NO₃)₂ solution. The first salt solution was first added to 445.43 mL of 2.69 mol/L NaOH solution for precipitation, and the precipitate was filtered and washed. in an autoclave, such that the temperature of the slurry reached 110° C. for 5 hours. the second mixed salt solution was introduced into the washed precipitate slurry and stoichiometric NH₄OH was added, such that yttrium ions, cerium ions and zirconium ions were precipitated on the surface. The suspension was filtered and dried, then calcined in a muffle furnace at 850° C. for 3 hours, taken out, ground, and calcined at 1000° C. and 1100° C. for 4 hours to obtain a product.

### Example 7

This example relates to the preparation of a composite oxide of 40% of cerium, 40% of zirconium, 15% of yttrium and 5% of praseodymium based on mole fractions of oxides.

The specific preparation process was as follows: two salt solutions were prepared in advance, where the first salt solution was composed of 41.60 mL of 1.5 mol/L CeCl₃ solution, 46.23 mL of 1.5 mol/L ZrOCl₂, 131.76 mL of 1.5 mol/L PrCl₃ and 83.02 mL of 2.1 mol/L H₂SO₄ solution, and the second salt solution was composed of 34.67 mL of 1.5 mol/L YCl₃, 4.62 mL of 1.5 mol/L CeCl₃ solution and 2.31 mL of 1.5 mol/L ZrOCl₂ solution. The first salt solution was first added to 458.83 mL of 2.69 mol/L NaOH solution for precipitation, and the precipitate was filtered and washed. The second mixed salt solution was then introduced into the washed precipitate slurry and stoichiometric NaOH was added, such that yttrium ions, cerium ions and zirconium ions were precipitated on the surface. After precipitation, the slurry was heated to 55° C. and maintained for 2 hours, After filtration and washing, oleic acid was added and heated to 98° C. for 1 hour. The suspension was filtered and dried, then calcined in a muffle furnace at 850° C. for 4 hours, taken out, ground, and calcined at 1000° C. and 1100° C. for 4 hours to obtain a product.

### Example 8

This example relates to the preparation of a composite oxide of 40% of cerium, 40% of zirconium, 18% of yttrium and 2% of praseodymium based on mole fractions of oxides.

The specific preparation process was as follows: two salt solutions were prepared in advance, where the first salt solution was composed of 89.28 mL of 1.5 mol/L CeCl₃ solution, 53.56 mL of 1.5 mol/L ZrOCl₂, 26.78 mL of 1.5 mol/L PrCl₃ and 158.77 mL of 2.1 mol/L H₂SO₄ solution, and the second salt solution was composed of 80.35 mL of 1.5 mol/L YCl₃ solution and 35.71 mL of 1.5 mol/L ZrOCl₂ solution. The first salt solution was first added to 527.71 mL of 2.69 mol/L NaOH solution for precipitation, and the precipitate was filtered and washed. The second mixed salt solution was then introduced into the washed precipitate slurry within 15 minutes and stoichiometric NaOH was added, such that yttrium ions and zirconium ions were precipitated on the surface. After precipitation, the slurry was heated to 80° C. and maintained for 4 hours, After filtration and washing, PEG was added in an autoclave, Heat to 120° C. for 6 hours. . The suspension was filtered and dried, then calcined in a muffle furnace at 800° C. for 5 hours, taken out, ground, and calcined at 1000° C. and 1100° C. for 4 hours to obtain a product.

### Example 9

This example relates to the preparation of a composite oxide of 40% of cerium, 40% of zirconium, 10% of yttrium and 10% of neodymium based on mole fractions of oxides.

The specific preparation process was as follows: two salt solutions were prepared in advance, where the first salt solution was composed of 82.58 mL of 1.5 mol/L CeCl₃ solution, 91.76 mL of 1.5 mol/L ZrOCl₂, 45.88 mL of 1.5 mol/L NdCl₃ and 165.54 mL of 2.1 mol/L H₂SO₄ solution, and the second salt solution was composed of 45.88 mL of 1.5 mol/L YCl₃, 9.17 mL of 1.5 mol/L CeCl₃ solution and 4.58 mL of 1.5 mol/L ZrOCl₂ solution. The first salt solution was first added to 496.32 mL of 2.69 mol/L NaOH solution for precipitation, and the precipitate was filtered and washed. The second mixed salt solution was then introduced into the washed precipitate slurry within 15 minutes and stoichiometric NaOH was added, such that yttrium ions, cerium ions and zirconium ions were precipitated on the surface. After filtration and washing, hexenic acid was added, in an autoclave, Heat to 150° C. for 6 hours. The suspension was filtered and dried, then calcined in a muffle furnace at 700° C. for 6 hours, taken out, ground, and calcined at 1000° C. and 1100° C. for 4 hours to obtain a product.

### Example 10

This example relates to the preparation of a composite oxide of 30% of cerium, 40% of zirconium, 10% of yttrium and 20% of aluminum based on mole fractions of oxides.

The specific preparation process was as follows: two salt solutions were prepared in advance, where the first salt solution was composed of 75.05 mL of 1.5 mol/L CeCl₃ solution, 105.63 mL of 1.5 mol/L ZrOCl₂, 111.19 mL of 1.5 mol/L AlCl₃ and 109.42 mL of 2.1 mol/L H₂SO₄ solution, and the second salt solution was composed of 55.59 mL of 1.5 mol/L YCl₃, 8.33 mL of 1.5 mol/L CeCl₃ solution and 5.55 mL of 1.5 mol/L ZrOCl₂ solution. The first salt solution was first added to 652.56 mL of 2.69 mol/L NaOH solution for precipitation, and the precipitate was filtered and washed. The second mixed salt solution was then introduced into the washed precipitate slurry within 15 minutes and stoichiometric NaOH was added, such that yttrium ions, cerium ions and zirconium ions were precipitated on the surface. After precipitation, the slurry was heated to 60° C. and maintained for 3 hours, After filtration and washing, lauric acid was then added, in an autoclave, Heat to 110° C. for 6 hours. The suspension was filtered and dried, then calcined in a muffle furnace at 750° C. for 5 hours, taken out, ground, and calcined at 1000° C. and 1100° C. for 4 hours to obtain a product.

### Example 11

This example relates to the preparation of a composite oxide of 40% of cerium, 40% of zirconium, 5% of yttrium, 7.5% of lanthanum and 7.5% of aluminum based on mole fractions of oxides.

The specific preparation process was as follows: two salt solutions were prepared in advance, where the first salt solution was composed of 89.15 mL of 1.5 mol/L CeCl₃ solution, 94.11 mL of 1.5 mol/L ZrOCl₂, 37.15 mL of 1.5 mol/L LaCl₃, 37.15 mL of 1.5 mol/L AlCl₃ and 70.76 mL of 2.1 mol/L H₂SO₄ solution, and the second salt solution was composed of 24.76 mL of 1.5 mol/L YCl₃, 9.90 mL of 1.5 mol/L CeCl₃ solution and 4.95 mL of 1.5 mol/L ZrOCl₂ solution. The first salt solution was first added to 535.83 mL of 2.69 mol/L NaOH solution for precipitation, and the precipitate was filtered and washed. The second mixed salt solution was then introduced into the washed precipitate slurry within 15 minutes and stoichiometric NaOH was added, such that yttrium ions, cerium ions and zirconium ions were precipitated on the surface. After filtering and washing, CTAB was added and placed in an autoclave, and treated at 150° C. for 2 hours. The suspension was filtered and dried, then calcined in a muffle furnace at 950° C. for 3 hours, taken out, ground, and calcined at 1000° C. and 1100° C. for 4 hours to obtain a product.

### Example 12

This example relates to the preparation of a composite oxide of 40% of cerium, 40% of zirconium, 4% of yttrium, 15.5% of lanthanum and 0.5% of manganese based on mole fractions of oxides.

The specific preparation process was as follows: two salt solutions were prepared in advance, where the first salt solution was composed of 71.72 mL of 1.5 mol/L CeCl₃ solution, 80.69 mL of 1.5 mol/L ZrOCl₂, 69.48 mL of 1.5 mol/L LaCl₃, 2.24 mL of 1.5 mol/L MnCl₃ and 64.04 mL of 2.1 mol/L H₂SO₄ solution, and the second salt solution was composed of 17.93 mL of 1.5 mol/L YCl₃, 17.93 mL of 1.5 mol/L CeCl₃ solution and 8.96 mL of 1.5 mol/L ZrOCl₂ solution. The first salt solution was first added to 499.60 mL of 2.69 mol/L NaOH solution for precipitation, and the precipitate was filtered and washed. The second mixed salt solution was then introduced into the washed precipitate slurry within 15 minutes and stoichiometric NaOH was added, such that yttrium ions, cerium ions and zirconium ions were precipitated on the surface. After precipitation, the slurry was heated to 60° C. and maintained for 1 hour, After filtering and washing, polyethylene glycol was added, in an autoclave, and heated to 120° C. for 6 hours. The suspension was filtered and dried, then calcined in a muffle furnace at 860° C. for 4 hours, taken out, ground, and calcined at 1000° C. and 1100° C. for 4 hours to obtain a product.

The oxide content (mole percent) of each composition in the above comparative examples and examples was shown in Table 1 below, and the specific surface area, pore volume and oxygen storage performance data of each composition were shown in Table 2. Data on the ratios of Y₂O₃, ZrO₂, CeO₂ and MOₓ (MOₓ represent the oxides of rare earth elements except cerium and yttrium and oxides of non-rare earth elements except zirconium) to shell surface and total elements in each composition were shown in Table 3.

TABLE 1
Oxide content (mole percent) of each composition in comparative examples and examples

| Number | % CeO₂ | % ZrO₂ | % Y₂O₃ | % La₂O₃ | % Nd₂O₃ | % Pr₆O₁₁ | % Al₂O₃ | % Mn₂O₃ |
|---|---|---|---|---|---|---|---|---|
| Comparative | 40 | 50 | 5 | 5 | — | — | — | — |
| Example 1 | | | | | | | | |
| Comparative | 40 | 40 | 5 | 7.5 | — | — | 7.5 | — |
| Example 2 | | | | | | | | |
| Example 1 | 10 | 70 | 20 | — | — | — | — | — |
| Example 2 | 20 | 59 | 3 | 18 | — | — | — | — |
| Example 3 | 40 | 50 | 5 | 5 | — | — | — | — |
| Example 4 | 50 | 30 | 10 | 10 | — | — | — | — |
| Example 5 | 60 | 20 | 18 | 2 | — | — | — | — |
| Example 6 | 40 | 40 | 1 | — | — | 19 | — | — |
| Example 7 | 40 | 40 | 15 | — | — | 5 | — | — |
| Example 8 | 40 | 40 | 18 | — | — | 2 | — | — |
| Example 9 | 40 | 40 | 10 | — | 10 | — | — | — |
| Example 10 | 30 | 40 | 10 | — | — | — | 20 | — |
| Example 11 | 40 | 40 | 5 | 7.5 | — | — | 7.5 | — |
| Example 12 | 40 | 40 | 4 | 15.5 | — | — | — | 0.5 |

TABLE 2
Data on specific surface area and oxygen storage performance
of each composition in comparative examples and examples

| | | | 1000° C. × 4 h | |
|---|---|---|---|---|
| | 1000° C. × 4 h - | 1100° C. × 4 h - | oxygen storage | oxygen storage |
| | specific surface | specific surface | capacity/(μmol | capacity/(μmol |
| Number | area (m²/g) | area (m²/g) | O₂/g) | O₂/g) |
| Comparative | 46.7 | 31.6 | 502 | 373 |
| Example 1 | | | | |
| Comparative | 48.2 | 35.3 | 493 | 351 |
| Example 2 | | | | |
| Example 1 | 63.4 | 53.5 | 630 | 537 |
| Example 2 | 60.9 | 50.3 | 638 | 556 |
| Example 3 | 71.7 | 57.6 | 690 | 591 |
| Example 4 | 64.1 | 52.6 | 676 | 571 |
| Example 5 | 61.1 | 51.1 | 611 | 536 |
| Example 6 | 58.6 | 50.3 | 692 | 599 |
| Example 7 | 67.3 | 56.0 | 683 | 596 |
| Example 8 | 66.5 | 53.9 | 630 | 519 |
| Example 9 | 62.3 | 50.3 | 691 | 586 |
| Example 10 | 70.6 | 54.5 | 603 | 501 |
| Example 11 | 69.6 | 53.3 | 606 | 510 |
| Example 12 | 60.1 | 51.7 | 763 | 623 |

TABLE 3
Data on ratios (mole percent) of Y₂O₃, ZrO₂, CeO₂ and MOₓ to shell elements and total
elements in each composition (fresh sample) of comparative examples and examples

| | Y₂O₃ | ZrO₂ | CeO₂ | MOₓ | Y₂O₃ | ZrO₂ | CeO₂ | MOₓ |
|---|---|---|---|---|---|---|---|---|
| Number | (surface) | (surface) | (surface) | (surface) | (total) | (total) | (total) | (total) |
| Comparative | 4.64 | 51.38 | 38.01 | 5.97 | 4.96 | 49.89 | 40.06 | 5.09 |
| Example 1 | | | | | | | | |
| Comparative | 4.33 | 41.75 | 39.19 | 14.73 | 5.09 | 39.92 | 40.09 | 14.90 |
| Example 2 | | | | | | | | |
| Example 1 | 64.12 | 28.16 | 7.72 | 0 | 20.15 | 69.86 | 9.99 | 0 |
| Example 2 | 2.39 | 22.78 | 60.47 | 14.36 | 2.03 | 59.23 | 19.93 | 18.81 |
| Example 3 | 6.98 | 15.28 | 75.57 | 2.17 | 4.98 | 50.17 | 39.88 | 4.97 |
| Example 4 | 19.67 | 10.46 | 64.38 | 5.49 | 9.94 | 29.87 | 50.16 | 10.03 |
| Example 5 | 65.01 | 1.20 | 33.00 | 0.79 | 13.09 | 19.90 | 64.91 | 2.10 |
| Example 6 | 1.51 | 14.26 | 74.57 | 9.66 | 1.02 | 40.29 | 39.92 | 18.77 |
| Example 7 | 31.93 | 13.94 | 52.07 | 2.06 | 14.89 | 39.81 | 40.23 | 5.07 |
| Example 8 | 48.03 | 14.12 | 37.43 | 0.42 | 17.91 | 40.26 | 39.89 | 1.94 |
| Example 9 | 18.78 | 15.48 | 61.65 | 4.09 | 10.07 | 39.82 | 39.87 | 10.24 |
| Example 10 | 26.53 | 13.91 | 52.76 | 6.80 | 9.89 | 39.93 | 30.19 | 19.99 |
| Example 11 | 10.95 | 13.97 | 69.45 | 5.63 | 4.86 | 40.30 | 39.90 | 14.94 |
| Example 12 | 11.16 | 15.86 | 64.64 | 8.34 | 3.98 | 40.29 | 39.81 | 15.92 |

The comparative examples and examples involved in the present disclosure included cerium-zirconium-based composite oxides with different compositions of high cerium, high zirconium, medium cerium and medium zirconium, and also included cerium-zirconium-based composite oxides with different partitions of ternary, quaternary and quinary elements, which basically covered the composition range and types of elements in the claims. By comparing the comparative examples and the examples, it was found that the specific surface area, pore volume and oxygen storage capacity of 1000° C.×4 h and 1100° C.×4 h aged samples were really effectively improved by step-by-step precipitation of yttrium, a part of zirconium and cerium, other rare earth elements except Ce and Y and the non-rare earth elements except zirconium on a cerium-zirconium surface, which was mainly reflected in the following two aspects:

Comparing the comparative examples and examples of cerium-zirconium-based composite oxides with different compositions of high cerium, high zirconium, medium cerium and medium zirconium, it can be found that the cerium-zirconium-based composite oxides prepared by the step-by-step precipitation method provided in this patent were superior in thermal stability and oxygen storage performance For example, the Ce_{0.40}Zr_{0.50}Y_{0.05}La_{0.05} composite oxide prepared by coprecipitation in Comparative Example 1 had a specific surface area of 31.6 m²/g and an oxygen storage capacity of 373 μmol O₂/g after being calcined at 1100° C. for 4 hours. The Ce_{0.40}Zr_{0.50}Y_{0.05}La_{0.05}composite oxide prepared by step-by-step precipitation (step-by-step post-precipitation of 10% Ce, 5% Zr and all Y) in Example 3 had a specific surface area of 57.6 m²/g and an oxygen storage capacity of 591 μmol O₂/g after being calcined at 1100° C. for 4 hours. For example, the Ce_{0.40}Zr_{0.40}Y_{0.05}La_{0.075}Al_{0.075} composite oxide prepared by coprecipitation in Comparative Example 2 had a specific surface area of 35.3 m²/g and an oxygen storage capacity of 351 μmol O²/g after being calcined at 1100° C. for 4 hours, while the Ce_{0.40}Zr_{0.40}Y_{0.05}La_{0.075}Al_{0.075} composite oxide prepared by step-by-step precipitation (step-by-step post-precipitation of 10% Ce, 5% Zr and all Y) in Example 11 had a specific surface area of 53.3 m²/g and an oxygen storage capacity of 510 μmol O₂/g after being calcined at 1100° C. for 4 hours.

To sum up, the present disclosure provides a cerium-zirconium-based composite oxide with a core-shell structure and a preparation method thereof, a catalyst system using the cerium-zirconium-based composite oxide, a catalytic converter for purifying tail gas by using the catalyst system, and application of the catalyst system or the catalytic converter in motor vehicle exhaust purification, industrial waste gas treatment or catalytic combustion. In the present disclosure, the cerium-zirconium-based composite oxide with a core-shell structure oxygen storage material is prepared by a step-by-step precipitation method. On the one hand, yttrium and a part of zirconium and cerium are precipitated on a cerium-zirconium surface, where the post-precipitation of yttrium is to segregate yttrium ions (Y³⁺) on a grain boundary surface, thus reducing lattice surface energy, pinning the grain boundary surface, making the migration of the grain boundary surface difficult, controlling the growth of grains, inhibiting the high-temperature sintering phenomenon of a solid solution, and then improving the thermal stability of the solid solution; the post-precipitation of a part of zirconium is to enhance the thermal stability, and the post-precipitation of a part of cerium is to enhance oxygen storage and release performance; on the other hand, the yttrium ions and other rare earth or non-rare earth ions have a smaller ion radius and charge amount, which is more conducive to reducing the formation of oxygen vacancies and improving the oxygen storage and release performance, so as to meet the use requirements of different catalysts for oxygen storage materials.

It should be understood that the above-mentioned specific embodiments of the present disclosure are merely used for illustrating or interpreting the principle of the present disclosure, rather than limiting the present disclosure. Therefore, any modification, equivalent substitution or improvement made without departing from the spirit and scope of the present disclosure shall fall into the protection scope of the present disclosure. Moreover, the appended claims of the present disclosure are intended to cover all variations and modifications falling within the scope and boundary of the appended claims or within the equivalent forms of such scope and boundary.

1. A cerium-zirconium-based composite oxide with a core-shell structure, wherein the composite oxide comprises yttrium oxide, cerium oxide, and zirconium oxide, wherein in percentage by mole (%), the content of yttrium oxide in a shell layer of the composite oxide is higher than that in the composite oxide, and the core layer of the composite oxide is cerium-zirconium-based composite oxide; the content of yttrium oxide in the core layer of the composite oxide is lower than that in the composite oxide, and the content of yttrium oxide in the shell layer of the composite oxide is 1.1-5.0 times that in the composite oxide; the content of zirconium oxide in the core layer of the composite oxide is higher than that in the composite oxide, and the content of zirconium oxide in the shell layer is 5%-40% of that in the composite oxide.

2. (canceled).

3. The cerium-zirconium-based composite oxide according to claim 1, wherein the composite oxide comprises the following terms represented as oxides:
10%-60% by mole of cerium oxide;
20%-70% by mole of zirconium oxide;
1%-20% by mole of yttrium oxide;
and 0%-20% by mole of other oxides.

4. The cerium-zirconium-based composite oxide according to claim 3, wherein the other oxides are one or a combination of more than one of oxides of rare earth elements except cerium and yttrium and oxides of non-rare earth elements except zirconium, the content of the other oxides in the composite oxide is 0%-18% by mole, and the content of the oxides of rare earth elements except cerium and yttrium in the other oxides is 0%-100% by mole.

5. The cerium-zirconium-based composite oxide according to claim 3, wherein the content of the other oxides in the composite oxide is 2%-15% by mole, and the content of the oxides of rare earth elements except cerium and yttrium in the other oxides is 50%-100% by mole.

6. The cerium-zirconium-based composite oxide according to claim 4, wherein in the other oxides, the rare earth elements except cerium and yttrium and the non-rare earth elements except zirconium are one or a combination of more than one of lanthanum, praseodymium, neodymium, samarium, europium, gadolinium, terbium, dysprosium, holmium, erbium, thulium, ytterbium, lutetium, scandium, hafnium, aluminum, barium, manganese, and copper.

7. The cerium-zirconium-based composite oxide according to claim 4, wherein in the other oxides, the rare earth elements except cerium and yttrium and the non-rare earth elements except zirconium are one or a combination of more than one of lanthanum, praseodymium, neodymium, europium, aluminum, and manganese.

8. The cerium-zirconium-based composite oxide according to claim 3, wherein the content of yttrium oxide in the shell layer is 1.5%-65% by mole of the total element content of the shell layer, and is at least higher than the total content of yttrium oxide in the composite oxide.

9. The cerium-zirconium-based composite oxide according to claim 3, wherein the oxides of rare earth elements except cerium and yttrium and the oxides of non-rare earth elements except zirconium in the shell layer are 0%-15% by mole of the total element content of the shell layer.

10. The cerium-zirconium-based composite oxide according to claim 1, wherein the composite oxide has:
a specific surface area of more than 60 m²/g after heat treatment at 1000° C. in air for 4 hours; and
a specific surface area of more than 50 m²/g after heat treatment at 1100° C. in air for 4 hours.

11. The cerium-zirconium-based composite oxide according to claim 1, wherein after the composite oxide is calcined at 1000° C. in air for 4 hours, its static oxygen storage capacity is more than or equal to 600 μmol O₂/g.

12. The cerium-zirconium-based composite oxide according to claim 1, wherein after the composite oxide is calcined at 1100° C. in air for 4 hours, its static oxygen storage capacity is more than or equal to 500 μmol O₂/g.

13. A preparation method of the cerium-zirconium-based composite oxide with a core-shell structure, wherein the preparation method is a step-by-step precipitation method, and comprises the following steps:
(a) first precipitation step: mixing alkaline matter with aqueous solution containing 80-100% by mole of cerium salt, 60-99% by mole of zirconium salt, and optionally at least one rare earth salt except the cerium salt and a yttrium salt or non-rare earth salt except the zirconium salt for precipitation filtering and washing to obtain a precipitate slurry A containing at least cerium and zirconium;
(b) second precipitation step: adding the yttrium salt, a solution of the remaining part of zirconium salt or cerium salt, and the alkaline matter to the slurry A for precipitation, to obtain a precipitate slurry B containing at least zirconium, cerium and yttrium; and
(c) adding a modifier to the slurry B for surface modification treatment, filtering to obtain a cerium-zirconium-based composite precipitate C, and calcining at 600° C.-950° C. to obtain the cerium-zirconium-based composite oxide.

14. The method according to claim 13, wherein the precipitate slurry A or B is aged.

15. The method according to claim 13, wherein the aqueous solution of the rare earth salt is one or a combination of more than one of a rare earth nitrate solution, a chloride solution, a sulfate solution, and an acetate solution; and the aqueous solution of the zirconium salt is one or a combination of more than one of a zirconium oxynitrate solution, a zirconium oxysulfate solution, a zirconium oxychloride solution, and a zirconium acetate salt.

16. The method according to claim 13, wherein the alkaline matter is one or a combination of more than one of sodium hydroxide, ammonium hydroxide, potassium hydroxide, urea, ammonium bicarbonate, sodium carbonate, and sodium bicarbonate.

17. The method according to claim 13, wherein the molar ratio of coordination agent ions to zirconium ions in the aqueous solution of the rare earth salt is 0.2-3.0, and the coordination agent ions are sulfate anions.

18. The method according to claim 17, wherein the molar ratio of the coordination agent ions to the zirconium ions is 0.5-2.5.

19. The method according to claim 13, wherein the modifier comprises one or more of an anionic surfactant, a nonionic surfactant, polyethylene glycol, carboxylic acid and salts thereof, and a carboxymethylated fatty alcohol ethoxylate type surfactant.

20. A catalyst system, wherein the catalyst system comprises the cerium-zirconium-based composite oxide according to claim 1.

22. Application of the cerium-zirconium-based composite oxide according to claim 1.
